(19) United States
(12) Patent Application Publication
(10) Pub. No.: US 2021/0084230 A1
(43) Pub. Date: Mar. 18, 2021

(54) Information Processing Method, Terminal and Readable Storage Medium

(71) Applicant: Gree Electric Appliances, Inc. of Zhuhai, Zhuhai, Guangdong (CN)

(72) Inventors: Pengfei XU, Zhuhai, Guangdong (CN); Yingjiang MA, Zhuhai, Guangdong (CN); Ping YANG, Zhuhai, Guangdong (CN); Yichao DENG, Zhuhai, Guangdong (CN)

(21) Appl. No.: 17/042,357

(22) PCT Filed: Dec. 21, 2018
(86) PCT No.: PCT/CN2018/122497

§ 371 Date: Sep. 28, 2020

(30) Foreign Application Priority Data
May 18, 2018 (CN) 201810479463.9

(51) Int. Cl. H04N 5/232; G06F 1/3287; G06F 1/3228

(52) U.S. Cl. CPC H04N 5/232411; H04N 5/247; G06F 1/3228; G06F 1/3287

(57) ABSTRACT

An information processing method, a terminal, and a readable storage medium are provided for solving the technical problem that a mobile phone is stuck when photographing by dual cameras. The method includes that: when photographing by multiple cameras included in a terminal, a first pixel value of a current photographed image is acquired; the terminal determines that a total Central Processing Unit (CPU) occupancy rate is greater than or equal to a first threshold, wherein the first threshold is, after a pixel value of a photographing application corresponding to the plurality of cameras is set to the first pixel value, a maximum value of the total CPU occupancy rate allowed when the photographing application is running; and the terminal turns off at least one of applications running in the background, as to that the total CPU occupancy rate is less than the first threshold.

### CROSS REFERENCE TO RELATED APPLICATIONS

The present disclosure claims priority to Chinese Patent Application No. 201810479463.9, filed on May 18, 2018 and entitled “Information Processing Method, Terminal and Readable Storage Medium”, the disclosure of which is hereby incorporated by reference in its entirety.

### TECHNICAL FIELD

The present disclosure relates to the technical field of computers, and more particularly, to an information processing method, a terminal and a readable storage medium.

### BACKGROUND

At present, a dual-camera photographing function of a mobile phone, that is, photographing through two rear cameras, is gradually popularized. The dual-camera photographing function makes a visual effect of photographed images better, but the dual-camera photographing function also has some drawbacks. For example, the algorithm precision and complexity of the dual-camera photographing function are obviously higher than the algorithm precision and complexity of single-camera photographing, and the algorithm precision and complexity directly affect the visual effect of the photographed image. As the visual effect of the photographed image is better, the algorithm precision and complexity are higher, and then Central Processing Unit (CPU) resources occupied by processing during photographing are more. Therefore, it is easier to make the mobile phone stuck when photographing images with better pixels, and due to the sticking of the mobile phone, it is also very likely that the quality of the photographed image is poor, which in turn makes the user experience poor.

### SUMMARY

In view of this, the present disclosure discloses an information processing method, a terminal, and a readable storage medium, which are used to solve the technical problem that a mobile phone is stuck when dual-camera photographing in the related art.

In a first aspect, an information processing method is provided, which includes that:

when photographing by multiple cameras included in a terminal, a first pixel value of a current photographed image is acquired;

the terminal determines that a total CPU occupancy rate is greater than or equal to a first threshold, wherein the first threshold is, after a pixel value of a photographing application corresponding to the plurality of cameras is set to the first pixel value, a maximum value of the total CPU occupancy rate allowed when the photographing application is running; and

the terminal turns off at least one of applications running in the background, as to that the total CPU occupancy rate is less than the first threshold.

In the method, when the terminal is photographing through multiple cameras, a first pixel value currently selected for photographing is acquired, and when the current total CPU occupancy rate of the terminal is greater than or equal to a first threshold, that is, a maximum value of the total CPU occupancy rate allowed at the first pixel value, some or all of applications running in the background are turned off. In this way, on the one hand, the processing ability of the CPU occupied by other applications can be reduced, and the sufficient processing ability is reserved for photographing through multiple cameras, so that the multiple cameras photograph more smoothly; on the other hand, after other applications are turned off, the power consumption of the other applications can be reduced, that is, the current total power consumption of the terminal is reduced, thus improving the endurance of the terminal. In addition, in the method, the first threshold corresponds to the first pixel value, and when the selected pixel values are different, the corresponding first thresholds may also be different, so that the terminal at any pixel value can achieve the effect of improving the endurance, and photographing with any pixel value can be smoother.

As at least one alternative embodiment, the operation that the terminal turns off at least one of applications running in the background includes that:

the terminal detects a CPU occupancy rate of each of the applications running in the background;

the terminal determines the at least one application from the applications running in the background according to the CPU occupancy rate of each application; and

the terminal turns off the at least one application.

In the method, when an application is turned off, which application is turned off may be determined according to the CPU occupancy rate of each application. For example, the application with a high CPU occupancy rate may be turned off preferentially, fewer applications may be turned off, and thus the process of turning off applications can be completed more quickly.

As at least one alternative embodiment, the operation that the terminal determines the at least one application from the applications running in the background according to the CPU occupancy rate of each application includes that:

the terminal determines the at least one application from the applications running in the background according to the CPU occupancy rate of each application and an importance level to which the each application belongs; or,

the terminal determines the at least one application from the applications running in the background according to the CPU occupancy rate of each application and a priority of the each application; or,

the terminal determines the at least one application from the applications running in the background according to the CPU occupancy rate of each application, an importance level to which the each application belongs, and a priority of the each application.

In the method, when the application is turned off, which application is turned off may be also determined according to the importance level and the priority of the application. For example, the importance level of the call application or the SMS application in the terminal is usually high, and these applications are usually not turned off when applications are turned off, as to ensure that users can communicate normally.

As at least one alternative embodiment, after the terminal turns off at least one of applications running in the background, the method further includes that:

when photographing by the plurality of cameras, the terminal determines that a first application automatically starts running in the background;

the terminal determines that a preset application list does not include the first application, wherein applications in the preset application list are allowed to run in the background when the plurality of cameras are photographing; and

the terminal turns off the first application.

In the method, some applications may automatically start running in the background. During the photographing through multiple cameras, if the application that is not in the preset application list automatically start running, the terminal will still turn off the application to ensure the smooth running of photographing, as to reduce the total power consumption of the terminal during photographing, and improve the endurance of the terminal.

In a second aspect, a terminal is provided, which includes:

an acquiring element, configured to acquire, when photographing by multiple cameras included in the terminal, a first pixel value of a current photographed image;

a determining element, configured to determine that a total CPU occupancy rate is greater than or equal to a first threshold, wherein the first threshold is, after a pixel value of a photographing application corresponding to the plurality of cameras is set to the first pixel value, a maximum value of the total CPU occupancy rate allowed when the photographing application is running; and

an executing element, configured to turn off, by the terminal, at least one of applications running in the background, as to that the total CPU occupancy rate is less than the first threshold.

As at least one alternative embodiment, the executing element is configured to:

detect a CPU occupancy rate of each of the applications running in the background;

determine the at least one application from the applications running in the background according to the CPU occupancy rate of each application; and

turn off the at least one application.

As at least one alternative embodiment, the operation that the executing element determines the at least one application from the applications running in the background according to the CPU occupancy rate of each application includes that:

the executing element determines the at least one application from the applications running in the background according to the CPU occupancy rate of each application and an importance level to which the each application belongs; or,

the executing element determines the at least one application from the applications running in the background according to the CPU occupancy rate of each application and a priority of the each application; or,

the executing element determines the at least one application from the applications running in the background according to the CPU occupancy rate of each application, an importance level to which the each application belongs, and a priority of the each application.

As at least one alternative embodiment,

the determining element is further configured to determine, when photographing by the plurality of cameras, that a first application automatically starts running in the background, and determine that a preset application list does not include the first application, wherein applications in the preset application list are allowed to run in the background when the plurality of cameras are photographing; and

the executing element is further configured to turn off the first application.

In a third aspect, a terminal is provided.

The terminal includes a processor, and the processor is configured to implement the method in the first aspect when executing a computer program stored in a memory.

In a fourth aspect, a readable storage medium is provided.

The readable storage medium stores a computer instruction that, when run on a computer, causes the computer to perform the method in the first aspect.

### BRIEF DESCRIPTION OF THE DRAWINGS

In order to more clearly illustrate the embodiments of the present disclosure or the technical solutions in the method/device known to the inventors, the drawings used in the description of the embodiments or the method/device known to the inventors will be briefly described below. It is apparent that the drawings in the following description are only embodiments of the present disclosure, and other drawings can be obtained from those skilled in the art according to the disclosed drawings without any creative work.

FIG. 1 is a schematic flowchart of an information processing method according to an embodiment of the present disclosure;

FIG. 2 is a schematic structural diagram of a terminal according to an embodiment of the present disclosure; and

FIG. 3 is another schematic structural diagram of a terminal according to an embodiment of the present disclosure.

### DETAILED DESCRIPTION OF THE EMBODIMENTS

The technical solutions in the embodiments of the present disclosure are clearly and completely described in the following with reference to the accompanying drawings in the embodiments of the present disclosure. It is apparent that the described embodiments are merely a part of the embodiments of the present disclosure, but not all of the embodiments. All other embodiments obtained by those of ordinary skill in the art based on the embodiments of the application without creative efforts should fall within the scope of protection of the application.

The technical background of the embodiments of the present disclosure is introduced below.

At present, a dual-camera photographing function of a mobile phone, that is, photographing through two rear cameras, is gradually popularized. The dual-camera photographing function makes a visual effect of photographed images better, but the dual-camera photographing function also has some drawbacks. For example, the algorithm precision and complexity of the dual-camera photographing function are obviously higher than the algorithm precision and complexity of single-camera photographing, and the algorithm precision and complexity directly affect the visual effect of the photographed image. As the visual effect of the photographed image is better, the algorithm precision and complexity are higher, and then CPU resources occupied by processing during photographing are more. Therefore, it is easier to make the mobile phone stuck when photographing images with better pixels, and due to the sticking of the mobile phone, it is also very likely that the quality of the photographed image is poor, which in turn makes the user experience poor.

In view of this, the present disclosure discloses an information processing method. In the method, when the terminal is photographing through multiple cameras, a first pixel value currently selected for photographing is acquired, and when the total CPU occupancy rate of the current terminal is greater than or equal to a first threshold, that is, a maximum value of the total CPU occupancy rate allowed when a pixel value of a current photographing application is set to the first pixel value, some or all of applications running in the background are turned off. In this way, on the one hand, the processing ability of the CPU, which is occupied by other applications can be reduced, and the sufficient processing ability is reserved for photographing through multiple cameras, so that the multiple cameras photograph more smoothly; on the other hand, after other applications are turned off, the power consumption of the applications can be reduced, that is, the current total power consumption of the terminal is reduced, thus improving the endurance of the terminal. In addition, in the method, the first threshold corresponds to the first pixel value, and when the selected pixel values are different, the corresponding first thresholds may also be different, so that the terminal at any pixel value can achieve the effect of improving the endurance, and photographing with any pixel value can be smoother.

The technical solutions disclosed in the present disclosure will be described below with reference to the drawings.

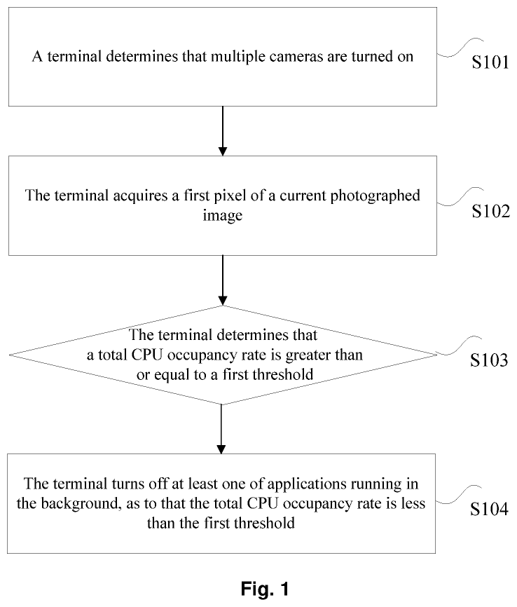

Referring to FIG. 1, the present disclosure discloses an information processing method. The method may be performed by a terminal disclosed in the present disclosure, and the terminal may be, for example, implemented by a device such as a mobile phone or a tablet computer (PAD). The flow of the method is described as follows.

In S101, the terminal determines that multiple cameras are turned on.

In the embodiment of the present disclosure, the terminal includes multiple cameras, and the terminal may also capture images through the multiple cameras. The multiple cameras may be arranged on the same plane of the terminal, for example, cameras of mobile phones capable of dual-camera photographing in the related art; or, the multiple cameras may also be arranged on different planes of the terminal, such as a front camera and a rear camera on the terminal.

As at least one alternative embodiment, generally speaking, when a user turns on a photographing application in a terminal, for example, when the user turns on a photographing application of a mobile phone system, or a photographing application installed by the user, a camera may be automatically turned on, that is, in the embodiment of the present disclosure, the correspondence between a photographing application and multiple cameras refers that the multiple cameras are triggered by the photographing application. According to the default setting of the terminal or the user's own settings, multiple cameras included in the terminal may be turned on when the conditions are met, for example, the terminal may turn on the photographing application by default, and then automatically turn on multiple cameras; or, the user can also set the corresponding options, for example, turn on the dual-camera photographing function, and then multiple cameras are turned on.

In S102, the terminal acquires a first pixel of a current photographed image.

In the embodiment of the present disclosure, when the user photographs an image through the photographing application in the terminal, the user may also be provided with an option for the user to select a pixel of the photographed image. Different pixels correspond to different visual effects of the image, and the options of the pixels may include, for example, 4K, 2K, 720P, and 480P.

After the user selects the pixel of the image, the pixel of the photographed image is the pixel selected by the user. Of course, when photographing images of different pixels, the processing required by the terminal is different. As the pixel is higher, the algorithm precision of the terminal when photographing is higher, so the processing ability of the terminal required is higher. Moreover, because the algorithm is more complicated, the power consumption of the terminal is correspondingly higher, the heating value is larger, and the endurance is worse, so the subsequent processing may be carried out for photographing images of different pixels.

In S103, the terminal determines that a total CPU occupancy rate is greater than or equal to a first threshold.

In the embodiment of the present disclosure, since the applications installed on the terminal are not only the photographing application, but also include various applications other than the photographing application. That is to say, in addition to the photographing application being run, other applications may continue to run in the background. The running of these applications also needs to occupy CPU resources. If other applications occupy too many resources, and there is no excess CPU resources in the terminal to provide algorithm calculation when multiple cameras are photographing, these multiple cameras are very likely to stick when photographing, or more seriously, terminal crash is directly caused, and the photographed images may also be unsatisfactory.

Therefore, in order to avoid the phenomenon of sticking when photographing by multiple cameras, the terminal detects the total CPU occupancy rate in real time after multiple cameras are turned on, and determine whether the total CPU occupancy rate exceeds the first threshold. The first threshold is, after a pixel value of a photographing application corresponding to the multiple cameras is set to the first pixel value, a maximum value of the total CPU occupancy rate allowed when the photographing application is running. That is to say, when the pixel values are different, the corresponding first thresholds may be different, and after the terminal obtains the first pixel value, the first threshold corresponding to the first pixel value may be determined according to the first pixel value.

When the photographing application is running, two states, namely a photographing state and a photographing pending state, may be included. The photographing state refers to a state when the user is photographing an image. The photographing pending state refers to a state when the photographing application is turned on, but no photographing is performed. For example, the photographing pending state may be a state when the user is focusing. In the two states, the required CPU resources may also be different, so different first thresholds may be set for the two different states, of course, the first thresholds of the two states may be the same, and the embodiment of the present disclosure is not limited thereto. The above-mentioned photographing application in running may refer to the photographing application running in the photographing state, or may also refer to the photographing application running in the photographing pending state.

As at least one alternative embodiment, the terminal may reserve a certain CPU resource for photographing with multiple cameras. For example, the CPU resource reserved by the terminal is a second threshold, and then the first threshold may be determined according to the second threshold. The second threshold may correspond to the first pixel value selected by the user. For example, as the pixel is higher, the algorithm precision when photographing through multiple cameras is higher, so more CPU resources is occupied accordingly, then the second threshold is larger, so that the first threshold may be correspondingly larger. For example, the ratio of CPU resources reserved by the terminal for photographing with multiple cameras to the total CPU resources is C %, that is, the second threshold is C %, when photographing with multiple cameras, the ratio of resources that may be occupied by applications running in the background to the total CPU resources is M %, and then the first threshold may be set to (C+M) %. The specific value of M % may be set according to the actual situation. For example, the specific value of M % may be set according to the CPU resources required by the application that needs run in the background in the terminal. Of course, in order to facilitate unified management, the first threshold corresponding to different pixel values may also be set to the same value.

In S104, the terminal turns off at least one of applications running in the background, as to that the total CPU occupancy rate is less than the first threshold.

In the embodiment of the present disclosure, when the terminal determines that the total CPU occupancy rate is greater than or equal to the first threshold, that is, the current total CPU occupancy rate of the terminal is very high, the terminal may be seriously heated, and there may be a stuck phenomenon when photographing with multiple cameras. Therefore, the number of applications that occupy CPU resources may be reduced by turning off at least one of the applications running in the background, so that the total CPU occupancy rate can be lower than the first threshold, thereby reducing the power consumption of the terminal, and avoiding excessive battery supply current and excessive temperature.

As at least one alternative embodiment, when the pixel value selected by the user is higher, the terminal needs to provide more CPU resources for photographing with multiple cameras, so that there may be more applications that need to be turned off. For convenience of comparison here, assuming that the first threshold is the same, when the pixel value selected by the user is higher, the algorithm complexity when photographing is higher, and then the CPU resources required are more. Then, that is to say, there are more CPU resources needing to be reserved by the terminal. Under the same first threshold, mere CPU resources occupied by applications running in the background can be compressed, and more applications need to be turned off.

As at least one alternative embodiment, when the terminal turns off at least one of the applications running in the background, the CPU occupancy rate of each of the applications running in the background may be first detected, and then at least one application needing to be turned off is determined according to the CPU occupancy rate of each application. For example, the terminal may sort the applications running in the background according to the order of the CPU occupancy of the applications, and then sequentially turn off the applications with the largest CPU occupancy rate. Every time one application is turned off, the current total CPU occupancy rate is calculated once until the total CPU occupancy rate is lower than the first threshold; or, the terminal may directly calculate a difference between the current total CPU occupancy rate and the first threshold, determine at least one application needing to be turned off according to the CPU occupancy rate of each application and the difference, and then sequentially turn off the applications.

In the embodiment of the present disclosure, some applications have a higher importance level on the terminal, such as calling or SMS applications. If these applications are turned off, the user may not be able to answer the phone or receive short messages in time, thereby bringing some trouble to the life and work of the user. Therefore, when turning off an application running in the background, the importance level of the application may also be considered. For example, at least one application that needs to be turned off may be determined by combining the CPU occupancy rate of each application and the importance level to which the application belongs. For example, the call or SMS application in the terminal may be set to the highest importance level, and the instant messaging application may be set to be the next to the call or SMS application.

When an application is running in the background, the application may correspond to multiple processes. Therefore, the so-called turning-off application in the embodiment of the present disclosure may also refer to turning off one or more processes of the application. For example, when the process of the application is turned off, the process that needs to be turned off may also be determined according to the importance level of the process. For example, in an instant messaging application, the importance level of a network connection process may be set to be higher than the importance level of a positioning process.

In the embodiment of the present disclosure, when turning off an application running in the background, the application that needs to be turned off may also be determined according to the set priority. The priority may be set when the terminal is shipped from the factory, or the priority may be set by the user according to own preferences, or the priority may be sorted according to the frequency of use of the application. As the frequency of use is higher, the priority is lower. The application with lower frequency of use is preferentially turned off when turning off.

In the embodiment of the present disclosure, when determining at least one application that needs to be turned off, it may also be comprehensively considered according to the CPU occupancy rate, the importance level, and the priority of the application.

In the embodiment of the present disclosure, some applications may automatically start running in the background. Because the applications occupy CPU resources, they may also affect the effect of multiple cameras when photographing. Therefore, when the terminal is photographing through the multiple cameras, if the terminal also detects that the first application automatically starts running in the background, the terminal may determine whether the first application is in a preset application list. If the preset application list includes the first application, the terminal does not process the first application. If the first application is not included in the application list, the terminal turns off the first application to prevent the first application from occupying CPU resources. The applications in the preset application list may be allowed to run in the background when the multiple cameras are photographing. For example, the applications in the preset application list may be more important applications such as a calling application or a short message application.

In conclusion, in the embodiment of the present disclosure, when the terminal is photographing through multiple cameras, a first pixel value currently selected for photographing is acquired, and when the total CPU occupancy rate of the current terminal is greater than or equal to a first threshold, that is, a maximum value of the total CPU occupancy rate allowed at the first pixel value, some or all of applications running in the background are turned off. In this way, on the one hand, the processing ability of the CPU, which is occupied by other applications can be reduced, and the sufficient processing ability is reserved for photographing through multiple cameras, so that the multiple cameras photograph more smoothly; on the other hand, after other applications are turned off, the power consumption of the applications can be reduced, that is, the current total power consumption of the terminal is reduced, thus improving the endurance of the terminal. In addition, in the method, the first threshold corresponds to the first pixel value, and when the selected pixel values are different, the corresponding first thresholds may also be different, so that the terminal at any pixel value can achieve the effect of improving the endurance, and photographing with any pixel value can be smoother.

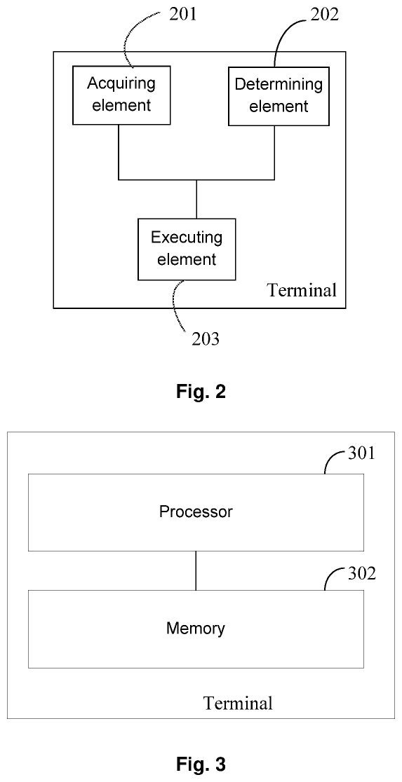

Referring to FIG. 2, based on the same inventive concept, the present disclosure discloses a terminal, which includes:

an acquiring element 201, configured to acquire, when photographing by multiple cameras included in the terminal, a first pixel value of a current photographed image;

a determining element 202, configured to determine that a total CPU occupancy rate is greater than or equal to a first threshold, wherein the first threshold is, after a pixel value of a photographing application corresponding to the plurality of cameras is set to the first pixel value, a maximum value of the total CPU occupancy rate allowed when the photographing application is running; and

an executing element 203, configured to turn off, by the terminal, at least one of applications running in the background, as to that the total CPU occupancy rate is less than the first threshold.

As at least one alternative embodiment, the executing element 203 is configured to:

detect a CPU occupancy rate of each of the applications running in the background;

determine the at least one application from the applications running in the background according to the CPU occupancy rate of each application; and

turn off the at least one application.

As at least one alternative embodiment, the operation that the executing element 203 determines the at least one application from the applications running in the background according to the CPU occupancy rate of each application includes that:

the executing element 203 determines the at least one application from the applications running in the background according to the CPU occupancy rate of each application and an importance level to which the each application belongs; or,

the executing element 203 determines the at least one application from the applications running in the background according to the CPU occupancy rate of each application and a priority of the each application; or,

the executing element 203 determines the at least one application from the applications running in the background according to the CPU occupancy rate of each application, an importance level to which the each application belongs, and a priority of the each application.

As at least one alternative embodiment,

the determining element 202 is further configured to determine, when photographing by the plurality of cameras, that a first application automatically starts running in the background, and determine that a preset application list does not include the first application, wherein applications in the preset application list are allowed to run in the background when the plurality of cameras are photographing; and

the executing element 203 is further configured to turn off the first application.

The device may be configured to perform the method disclosed in the embodiment as shown in FIG. 1. Therefore, functions and the like which may be achieved by each functional module of the device may refer to the description of the embodiment as shown in FIG. 1, and are not repeatedly described.

Referring to FIG. 3, based on the same inventive concept, an embodiment of the present disclosure discloses a terminal, which includes at least one processor 301, and the at least one processor 301 is configured to implement the steps of the information processing method disclosed in the embodiment as shown in FIG. 1 when a computer program stored in a memory is executed.

As at least one alternative embodiment, the at least one processor 301 may specifically include a CPU, and an Application Specific Integrated Circuit (ASIC), may be one or more integrated circuits configured to execute a control program, may be a hardware circuit developed by using a Field Programmable Gate Array (FPGA), and may be a base band processor.

As at least one alternative embodiment, the at least one processor 301 may include at least one processing core.

As at least one alternative embodiment, the terminal further includes a memory 302, and the memory 302 may include a Read Only memory (ROM), a Random Access Memory (RAM) and a magnetic disk memory. The memory 302 is configured to store data required when the at least one processor 301 runs. There are one or more memories 302. Herein, the memories 302 are shown together in FIG. 3, but it is to be noted that the memory 302 is not a necessary functional module, so it is shown in FIG. 3 by a dotted line.

Based on the same inventive concept, an embodiment of the present disclosure discloses a readable storage medium, having stored thereon a computer instruction that, when run on a computer, causes the computer to perform the steps of the information processing method disclosed in the embodiment as shown in FIG. 1.

In an alternative implementation process, the computer readable storage medium includes: a Universal Serial Bus flash drive (USB), a mobile hard disk drive, a Read-Only memory (ROM), a Random Access Memory (RAM), a magnetic disk or an optical disk and various storage mediums capable of storing program codes.

In the embodiment of the present disclosure, it should be understood that the disclosed devices and methods may be achieved in other ways. For example, the embodiments of the devices described above are only schematic, for example, the unit or the division of the unit is only a logical function division, and there may be other division modes in actual implementation, for example, multiple units or components may be combined or integrated into another system, or some features may be ignored, or not executed. In addition, the displayed or discussed mutual coupling or direct coupling or communication connection may be indirect coupling or communication connection through some interfaces, devices or units, and may be electrical or other forms.

Each functional unit in the embodiment of the present disclosure may be integrated in one processing unit, or each unit may also be an independent physical module.

The integrated unit may be stored in a computer-readable storage medium if being implemented in the form of a software functional unit and sold or used as a standalone product. Based on such understanding, all or part of the technical solutions of the embodiment of the present disclosure may be embodied in the form of a software product, the computer software product is stored in a storage medium, and includes several instructions which are used for enabling a computer device, such as a personal computer, a server, a network device, or a processor, to execute all or part of the steps of the method in each embodiment of the present disclosure. The above storage medium includes: a USB flash drive, a mobile hard disk drive, a ROM, a RAM, a magnetic disk or an optical disk and various mediums capable of storing program codes.

In conclusion, the above embodiments are only used to introduce the technical solutions of the present disclosure in detail, but the description of the above embodiments are only used to help understand the methods of the embodiments of the present disclosure, and should not be understood as the limitation to the embodiments of the present disclosure. Changes or replacements which may be easily imagined by those skilled in the art shall fall within a scope of protection of the embodiments of the present disclosure.

What is claimed is:

1. An information processing method, comprising:
when photographing by a plurality of cameras comprised in a terminal, acquiring a first pixel value of a current photographed image;
determining, by the terminal, that a total Central Processing Unit (CPU) occupancy rate is greater than or equal to a first threshold, wherein the first threshold is, when a pixel value of a photographing application corresponding to the plurality of cameras is set to the first pixel value, a maximum value of the total CPU occupancy rate allowed when the photographing application is running; and
turning off, by the terminal, at least one of applications running in the background, as to that the total CPU occupancy rate is less than the first threshold.

2. The method as claimed in claim 1, wherein turning off, by the terminal, the at least one of applications running in the background comprises:
detecting, by the terminal, a CPU occupancy rate of each of the applications running in the background;
determining, by the terminal, the at least one application from the applications running in the background according to the CPU occupancy rate of each application; and
turning off, by the terminal, the at least one application.

3. The method as claimed in claim 2, wherein determining, by the terminal, the at least one application from the applications running in the background according to the CPU occupancy rate of each application comprises:
determining, by the terminal, the at least one application from the applications running in the background according to the CPU occupancy rate of each application and an importance level to which the each application belongs; or,
determining, by the terminal, the at least one application from the applications running in the background according to the CPU occupancy rate of each application and a priority of the each application; or,
determining, by the terminal, the at least one application from the applications running in the background according to the CPU occupancy rate of each application, an importance level to which the each application belongs, and a priority of the each application.

4. The method as claimed in claim 1, wherein after turning off, by the terminal, the at least one of applications running in the background, the method further comprising:
when photographing by the plurality of cameras, determining, by the terminal, that a first application automatically starts running in the background;
determining, by the terminal, that a preset application list does not comprise the first application, wherein applications in the preset application list are allowed to run in the background when the plurality of cameras are photographing; and
turning off, by the terminal, the first application.

5. A terminal, comprising:
an acquiring element (201), configured to acquire, when photographing by a plurality of cameras comprised in the terminal, a first pixel value of a current photographed image;
a determining element (202), configured to determine that a total Central Processing Unit (CPU) occupancy rate is greater than or equal to a first threshold, wherein the first threshold is, after a pixel value of a photographing application corresponding to the plurality of cameras is set to the first pixel value, a maximum value of the total CPU occupancy rate allowed when the photographing application is running; and
an executing element (203), configured to turn off, by the terminal, at least one of applications running in the background, as to that the total CPU occupancy rate is less than the first threshold.

6. The terminal as claimed in claim 5, wherein the executing element (203) is configured to:
detect a CPU occupancy rate of each of the applications running in the background;
determine the at least one application from the applications running in the background according to the CPU occupancy rate of each application; and
turn off the at least one application.

7. The terminal as claimed in claim 6, wherein determining, by the executing element (203), the at least one application from the applications running in the background according to the CPU occupancy rate of each application comprises:
determining, by the executing element (203), the at least one application from the applications running in the background according to the CPU occupancy rate of each application and an importance level to which the each application belongs; or,
determining, by the executing element (203), the at least one application from the applications running in the background according to the CPU occupancy rate of each application and a priority of the each application; or,
determining, by the executing element (203), the at least one application from the applications running in the background according to the CPU occupancy rate of each application, an importance level to which the each application belongs, and a priority of the each application.

8. The terminal as claimed in claim 5, wherein
the determining element (202) is further configured to determine, when photographing by the plurality of cameras, that a first application automatically starts running in the background, and determine that a preset application list does not comprise the first application, wherein applications in the preset application list are allowed to run in the background when the plurality of cameras are photographing; and
the executing element (203) is further configured to turn off the first application.

9. A terminal, comprising:
a processor (301), wherein the processor (301) is configured to implement the method as claimed in claim 1 when executing a computer program stored in a memory.

10. A readable storage medium,
storing a computer instruction that, wherein when the computer instruction runs on a computer, the computer is caused to perform the method as claimed in claim 1.

11. The method as claimed in claim 2, wherein after turning off, by the terminal, the at least one of applications running in the background, the method further comprising:
when photographing by the plurality of cameras, determining, by the terminal, that a first application automatically starts running in the background;
determining, by the terminal, that a preset application list does not comprise the first application, wherein applications in the preset application list are allowed to run in the background when the plurality of cameras are photographing; and
turning off, by the terminal, the first application.

12. The method as claimed in claim 3, wherein after turning off, by the terminal, the at least one of applications running in the background, the method further comprising:
when photographing by the plurality of cameras, determining, by the terminal, that a first application automatically starts running in the background;
determining, by the terminal, that a preset application list does not comprise the first application, wherein applications in the preset application list are allowed to run in the background when the plurality of cameras are photographing; and
turning off, by the terminal, the first application.

13. The terminal as claimed in claim 6, wherein
the determining element (202) is further configured to determine, when photographing by the plurality of cameras, that a first application automatically starts running in the background, and determine that a preset application list does not comprise the first application, wherein applications in the preset application list are allowed to run in the background when the plurality of cameras are photographing; and
the executing element (203) is further configured to turn off the first application.

14. The terminal as claimed in claim 7, wherein
the determining element (202) is further configured to determine, when photographing by the plurality of cameras, that a first application automatically starts running in the background, and determine that a preset application list does not comprise the first application, wherein applications in the preset application list are allowed to run in the background when the plurality of cameras are photographing; and
the executing element (203) is further configured to turn off the first application.
